(19) United States
(12) Patent Application Publication
(10) Pub. No.: US 2005/0101687 A1
(43) Pub. Date: May 12, 2005

(54) Photopolymerizable composition and photopolymerizable film prepared therefrom

(76) Inventors: Eunkyoung Kim, Daejeon (KR); Ji Young Park, Daejeon (KR)

Correspondence Address: David A Einhorn;Anderson Kill & Olick, 1251 Avenue of the Americas, New York, NY, 10020, US

(21) Appl. No.: 10/507,933

(22) PCT Filed: Jan. 10, 2004
(86) PCT No.: PCT/KR04/00030

(30) Foreign Application Priority Data
Jan. 10, 2003 (KR) 10-2003-0001654

(51) Int. Cl. C08J 3/28

(52) U.S. Cl. 522/121

(57) ABSTRACT

A photopolymerizable composition of the present invention, comprising a specific acryl- or methacryl-based compound in combination with a binder which is a siloxane precursor-containing sol-gel solution or a transparent polymer resin, can provide a photopolymerizable film having an improved recording property when photocured.

### FIELD OF THE INVENTION

The present invention relates to a photopolymerizable composition, and a photopolymerizable film having an improved recording property, prepared from said composition which exhibits a low shrinkage and a high refractive index change when photocured.

### BACKGROUND OF THE INVENTION

Photochemical polymerization that accomplishes the polymerization of a compound by irradiating a light is used in various applications including is paints, plates for print, printed circuits, accumulated circuits, information recording and electronic apparatus. Such polymerization can be advantageously used for rapid polymerization under a mild condition through turning of the polymerization rate and extent by controlling the intensity or wavelength of the incipient light.

Hitherto, various photopolymerizable compositions have been reported. For example, Korean Patent Publication Nos. 1992-4450, 1991-17382, 1991-1467, 1990-3685, 1989-10615 and 1988-11262, and U.S. patent application Ser. No. 08/698,142 disclose a photopolymerizable composition comprising a polymerizable ester which is prepared by reacting an alcohol with acylic acid or methacylic acid (e.g., ethylene glycol diacrylate).

The above polymerizable composition, however, gives a relatively large degree of shrinkage of the film during a photo-recording process, which makes it difficult to decode the information stored on the film.

In order to solve the above problem, a technique to compensate for such polymerization shrinkage has been developed by way of adding a spiro-compound expanding agent in a polymerizable composition (see [Expanding Monomers: Synthesis. Characterization, and Applications (R. K. Sadhir and R. M. Luck, eds., 1992) 1-25, 237-260]; [T. Takata and T. Endo, “Recent Advances in the Development of Expanding Monomers: Synthesis, Polymerization and Volume Change”, Prog. Polym. Sci., Vol. 18, 1993, 839-870]; and U.S. Pat. No. 6,221,536). However, such a shrinkage compensation technique is based on partial phase changes which is only marginally effective, besides the problem that it is difficult to control the rate of the spiro opening reaction (see [C. Bolln et al., “Synthesis and Photoinitiated Cationic Polymerization of 2-methylene-7-phenyl-1,4,6,9-tetraoxaspiro[4,4]nonane”, Macromolecules, Vol. 29, 1996, 3111-3116]).

U.S. Pat. No. 6,268,089 discloses a photorecording medium for holography comprising a photocurable monomer and a silicone, titanium, germanium, zirconium, banadium or aluminum-based organic-inorganic hybrid precursor. However, during heating to polymerize the organic-inorganic hybrid precursor, undesired polymerization of the photocurable monomer occurs, which lowers the photo-recording efficiency.

Accordingly, the present inventors have endeavored to find out whether a photopolymerizable film exhibiting a low shrinkage and a high refractive index change when photocured can be developed by way of combining the photopolymerizable composition comprising an acryl- or methacryl-based compound disclosed in Korean Patent Application No. 2002-43890 and Korean Patent No. 357685 with a specific binder and a photoinitiator.

### SUMMARY OF THE INVENTION

Accordingly, it is a primary object of the present invention to provide a photopolymerizable composition which exhibits a low degree of shrinkage and a high refractive index change when photocured.

It is another object of the present invention to provide a photopolymerizable film having an improved recording property, which is prepared from said composition.

In accordance with one aspect of the present invention, there is provided a photopolymerizable composition which comprises 1) an acryl- or methacryl-based compound of formula (I), 2) a binder which is a sol-gel solution obtained from a siloxane precursor of formula (II) or a transparent polymeric resin, and 3) a photoinitiator: 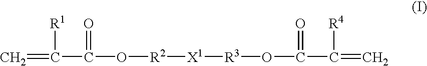
wherein:
R¹ and R⁴ are each independently hydrogen or CH₃;
R² and R³ are each independently R⁵ or 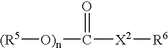
(R⁵ and R⁶ are each independently C₁₋₁₀ alkylene, arylene, —OCH₂CH₂—, —SCH₂CH₂— or 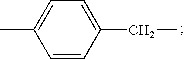
and n is an integer in the range of 1 to 10); and
X¹ is O, S, SO₂, 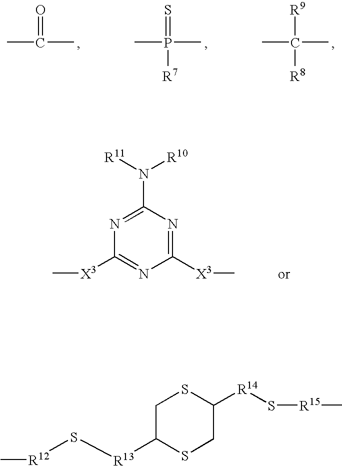
(X² and X³ are each independently O or S;
R⁷ is C₁₋₁₀ alkylthioether, phenyl, 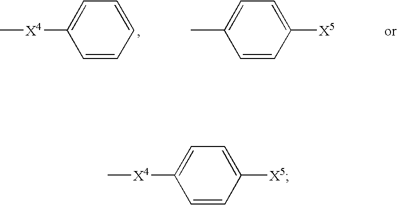
X⁴ is O, S, CH₂ or SCH₂; X⁵ is SCH₃, OCH₃ or phenyl; R⁸, R⁹, R¹⁰ and R¹¹ are each independently H, C₁₋₁₀ alkyl, C₃₋₁₀ cyclic alkyl, phenyl, benzyl or CF₃; and R¹², R¹³, R¹⁴ and R¹⁵ are each independently C₁₋₁₀ alkylene). 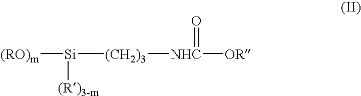
wherein:
R and R′ are each independently C₁₋₁₀ alkyl or phenyl;
R″ is R or —(R—O)ₚ—Y;
Y is R′, CF₃, SO₂CH₃or 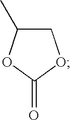
p is an integer in the range of 1 to 10; and
m is 0, 1, 2 or 3.

### BRIEF DESCRIPTION OF THE DRAWINGS

The above and other objects and features of the present invention will become apparent from the following description of the invention, when taken in conjunction with the accompanying drawings, which respectively show:

FIG. 1: an optical microphotograph of a grating pattern formed by holography on the photopolymerizable film prepared in Example 1; and

FIG. 2: transmission and diffraction image scanning microphotographs of the V-character formed by holography on the photopolymerizable film prepared in Example 1.

### DETAILED DESCRIPTION OF THE INVENTION

The photopolymerizable composition in accordance with a preferred embodiment of the present invention comprises 1) 1 to 80% by weight of an acryl- or methacryl-based compound of formula (I), 2) 19.99 to 98% by weight of a binder serving as a host to the compound of formula (I) which is a sol-gel solution prepared from a siloxane precursor of formula (II) or a transparent polymeric resin, and 3) 0.01 to 10% by weight of a photoinitiator.

The compound of formula (I) used in the present invention is a photopolymerizable monomer which plays the role of recording images and has the merits that it undergoes a large refractive index change but a minimal volume change when photopolymerized. The compound of formula (1) may be prepared by the methods disclosed in Korean Patent Application No. 2002-43890 and Korean Patent No. 357685 which are incorporated by reference in the present invention.

The binder used in the present invention is a sol-gel solution prepared from a composition comprising a siloxane precursor of formula (II) or a transparent polymeric resin. Such a sol-gel solution may be prepared by the method disclosed in Korean Patent No. 212534. Specifically, a mixture of 2 to 80% by weight of the siloxane precursor of formula (II), 2 to 80% by weight of tetraalkoxysilane, 0.01 to 30% by weight of hydrochloric acid and 0.1 to 80% by weight of an organic solvent is stirred at room temperature for 1 to 10 days and subsequently at a temperature ranging from 30 to 70° C. for 1 to 10 days, and then, the resulting solution is concentrated under a reduced pressure. The above reaction may be conducted in the presence of a di-functional or tri-functional organic alkoxysilane such as triethoxysilane, 3-glycidoxypropyltrimethoxysilane (GPTMS), methyltriethoxysilane and phenyltrimethoxysilane; an organic siloxane oligomer flake; or a basic catalyst such as an organic acid(e.g., acetic acid, trifluoroacetic acid), pyridine, 4-(N,N-dimethylaminopyridine) and cobalt dichloride.

Representative transparent polymeric resins which may be used as a binder include polyolefins, polystyrenes, polycarbonates, polyurethanes, polysulfones, polyacrylates and mixtures thereof. For the purpose of enhancing the solubility of the resin, at least one solvent selected from the group consisting of chloroform, dichloromethane, tetrahydrofuran, N-methylpyrrolidone, methylsulfoxide, N,N-dimethylacetamide, dioxane, alcohols(e.g., methanol, ethanol), benzene, ethylene glycol dimethyl ether, acetonitrile and water may be used in an amount ranging from 1 to 100 parts by weight based on 1 part by weight of the polymeric resin.

The photoinitiator used in the present invention is a reaction initiator which generates free radicals or cations by the action of irradiated light, and may be one selected from the group consisting of Irgacure 184, Irgacure 784, a metallocene catalyst, Darocure, acridine, phenazine, quinoxaline and a mixture thereof.

The inventive transparent photopolymerizable composition may be prepared by mixing at room temperature the acryl- or methacryl-based compound, the sol-gel solution or the transparent polymeric resin and the photoinitiator, followed by filtration.

The inventive composition may comprise as a co-monomer a compound selected from the group consisting of 2-naphtyl-1-oxyethylacrylate, 2-N-carbazolyl-1-oxyethyl)acrylate, N-vinylcarbazole, isobonylacrylate, phenoxyethylacrylate, diethylene glycol monomethyl ether acrylate, diethylene glycol biscarbonate, an allyl-based monomer, α-methylstyrene, styrene, divinylbenzene, polyethylene oxymethacrylate, polyethylene oxyacrylate, polyethylene oxydiacrylate, alkylene triacrylate and a mixture thereof.

In addition, the inventive composition may further comprise a photosensitizer in an amount ranging from 0.01 to 20% by weight based on the total amount of the composition. Exemplary photosensitizers may include anthracene, pherylene, Methyl red, Methyl orange, Methylene blue, pyrane derivatives, acridine compound, mono-, di- or tri-halomethyl-substituted triazine, quinazolinone and a mixture thereof.

Further, if necessary, the inventive composition may comprise an expanding agent, layer-phase silicate, antioxidant, dye, paint, lubricant, polymerization catalyst, UV-absorbent, coloring resistant and the like.

In accordance with the present invention, a transparent photopolymerizable film may be prepared by coating(e.g., spin coating, bar coating) the inventive composition on a substrate(e.g., a glass plate, ITO film, silicon wafer) and drying the coating at room temperature to 130° C. for 30 min to 14 days. The photopolymerizable film may have a thickness ranging from 0.0001 to 30mm.

The inventive photopolymerizable film exhibits a high refractive index change and a low shrinkage when polymerized by UV or visible ray irradiation, which makes it possible to efficiently record signals and also to reliably decode the recorded signals. In addition, when photocured, the inventive photopolymerizable film shows enhanced mechanical properties due to the siloxane polymer matrix formed from organic precursors.

The photopolymerizable composition and film of the present invention is useful for various applications including holography system, moving image system for display, photo-separator using volume hologram, optical head apparatus, liquid crystal display, multi-step grating, typesetting for print, photosensitive and corrosion-resisting film, information recording film and optical filter.

The following Preparations and Examples are given for the purpose of illustration only and are not intended to limit the scope of the invention.

1) Shrinkage

The degree of shrinkage, or simply shrinkage, of a sample film was determined by irradiating 532 nm laser to one part of the film for 5 min, and measuring the change in the film thickness with an α-step.

2) Diffraction Efficiency

The diffraction efficiency of a sample film was determined by measuring the diffracted intensity and transmitted intensity of hologram formed by irradiating a 532 nm laser at an incidence angle of 20 degree.

<Preparation of Sol-gel Solutions>

### PREPARATION EXAMPLE 1

15 g of 3-glycidoxypropyltrimethoxysilane(GPTMS), 12.78 g of tetraethoxysilane(TEOS), 8.36 g of methyltrimethoxysilane(MTMS) and 9.17 g of the compound of formula (II-a) were dissolved in 20 ml of 2-methoxyethanol and 20 ml of isopropylalcohol. 5 ml of 0.5N hydrochloric acid was slowly added to the mixed solution at 70° C. and stirred for 24 hrs under a nitrogen atmosphere. The reaction mixture was subjected to vacuum evaporation to obtain 33.53 g of a transparent organic-inorganic hybrid-type sol-gel solution. 0.168 g of tetraethylammonium perchlorate and 0.0168 g of Byk301 were added thereto with vigorously stirring, and filtered through a 0.45 μm filter, to obtain a transparent sol-gel solution.

### PREPARATION EXAMPLE 2

15 g of GPTMS, 12.78 g of tetramethoxysilane(TMOS), 8.36 g of phenyltrimethoxysilane and 12 g of the compound of formula (II-b) were dissolved in 20 ml of 2-methoxyethanol and 20 ml of isopropylalcohol. 6 ml of 0.5N hydrochloric acid was slowly added to the mixed solution at 70° C. and stirred for 10 hrs under a nitrogen atmosphere. The reaction mixture was subjected to vacuum evaporation to obtain 35 g of a transparent organic-inorganic hybrid-type sol-gel solution. 0.2 g of tetramethylammonium perchlorate was added thereto with vigorously stirring, and filtered through a 0.45 μm filter, to obtain a transparent sol-gel solution.

### PREPARATION EXAMPLES 3 TO 5

The procedure of Preparation Example 1 was repeated using the reactants and siloxane precursors shown in Table 1, to obtain transparent sol-gel solutions.

TABLE 1

| Preparation | Siloxane | | Weight after |
|---|---|---|---|
| No. | precursor (g) | Other reactants (g) | evaporation |
| 3 | Compound | GPTMS (15), TEOS (12.7), MTMS (8.3), | 32 g |
| | (II-a) (10) | 2-methoxyethanol (20 mL), isopropylalcohol | |
| | | (20 mL), 0.5N hydrochloric acid (5 mL), | |
| | | tetraethylammonium perchlorate (0.168 g), | |
| | | Byk301 (0.0168 g) | |
| 4 | Compound | GPTMS (15), TEOS (12.7), MTMS (8.3), | 35 g |
| | (II-c) (9.2) | 2-methoxyethanol (20 mL), ethanol (10), TNF | |
| | | (10), 0.5N hydrochloric acid (5 mL), | |
| | | tetraethylammonium perchlorate (0.11 g), | |
| | | Byk301 (0.0168 g), tetrabutylammonium (0.08 g) | |
| 5 | Compound | GPTMS (15), TEOS (12.7), MTMS (8.3), | 37 g |
| | (II-d) (10) | 2-methoxyethanol (20 mL), isopropylalcohol | |
| | | (20 mL), 0.5N hydrochloric acid (5 mL), | |
| | | tetraethylammonium perchlorate (0.168 g), | |
| | | Byk301 (0.0168 g) | |

(CH₃CH₂O)₃—Si—(CH₂)₃—NH—CO₂—(CH₂CH₂O)₇˜₈—CH₃ (II-a)
(CH₃O)₃—Si—(CH₂)₃—NH—CO₂—(CH₂CH₂O)₇˜₈—CH₃ (II-b)
(CH₃CH₂O)₃—Si—(CH₂)₃—NHCO₂—(CH₂CH₂O)₃—CH₂CH₃ (II-c)
(CH₃CH₂O)₃—Si—(CH₂)₃—NHCO₂—(CH₂CH₂O)₃—SO₂CH₃ (II-d)

<Synthesis of Inventive Photopolymerizable Compositions and Films>

### EXAMPLE 1

1.34 g of the aromatic methacrylate of formula (I-a) was dissolved in 2 g of the sol-gel solution obtained in Preparation Example 1, and 0.026 g of Irgacure 784 and 0.0052 g of tertiary butylhydroperoxide were added thereto with stirring. The resulting yellow mixture was filtered through a 0.45 μm filter, to obtain a transparent photopolymerizable composition.

Then, the photopolymerizable composition thus obtained was coated on the surface of a glass plate and dried at 70° C. for 48 hrs, to prepare a 200 μm thick and transparent photopolymerizable film.

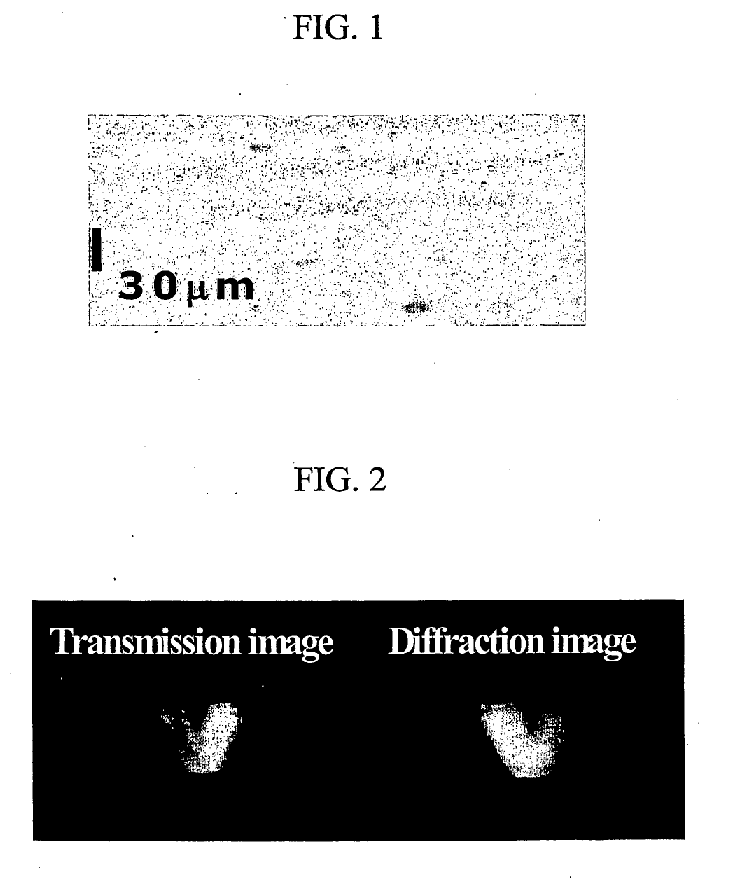

The film thus obtained showed a low shrinkage of 0.9% and a high diffraction efficiency of 70%. An optical microphotograph of a grating pattern formed by holography thereon is shown in FIG. 1, and transmission and diffraction image scanning microphotographs of the V-character, in FIG. 2.

### EXAMPLE 2

15 g of polysulfone and 10 g of the aromatic methacrylate of formula (I-a) were placed in a reaction vessel, and 40 g of chloroform, 20 g of trichloroethane and 0.2 g of Irgacure 784 were added thereto with stirring. The resulting yellow mixture was filtered through a 0.45 μm filter, to obtain a transparent photopolymerizable composition.

Then, the photopolymerizable composition obtained was coated on the surface of a glass plate and dried at 50° C. for 1 hr, to prepare a 200 μm thick and transparent photopolymerizable film.

The film thus obtained showed a low shrinkage of 1.5% and a high diffraction efficiency of 75%.

### EXAMPLE 3

1.34 g of the aromatic methacrylate of formula (I-a) and 0.33 g of 9-vinylcarbazole were dissolved in 2 g of the sol-gel solution obtained in Preparation Example 2, and 0.034 g of Irgacure 784, 0.0001 g of Methylene blue and 0.0068 g of tertiary butylhydroperoxide were added thereto with stirring. The resulting reddish yellow mixture was filtered through a 0.45 μm filter, to obtain a transparent photopolymerizable composition.

Then, the photopolymerizable composition obtained was coated on the surface of a glass plate and dried at 50° C. for 10 hrs, to prepare a 1 mm thick and transparent photopolymerizable film.

The film thus obtained showed a low shrinkage of 0.6% and a high diffraction efficiency of 65%.

### EXAMPLE 4

The procedure of Example 3 was repeated except that 1-vinyl-2-pyrrolidinone was used instead of 9-vinylcarbazole, to prepare a 1 mm thick transparent photopolymerizable film.

The film thus obtained showed a low shrinkage of 0.7% and a high diffraction efficiency of 50%.

### EXAMPLES 5 to 15

The procedure of Example 1 or 2 was repeated while changing the components and film manufacturing conditions as shown in Table 2, to prepare various transparent photopolymerizable compositions and films. The characteristics of the film thus obtained are shown in Table 2.

TABLE 2

| | | Film | | | |
|---|---|---|---|---|---|
| | | manufacturing | Thick- | Shrink- | Diffraction |
| Ex. | | condition: | ness | age | Efficiency |
| No. | Components (g) | method/° C./time | (mm) | (%) | (%) |
| 5 | ⁽⁵⁾Compound (I-a) (1), ⁽¹⁾PMMA (1.5), | Ex. 2/40/4 | 10.15 | 1.5 | 60 |
| | chloroform (4), ⁽²⁾TCE (2), | | | | |
| | Irgacure 784 (0.02), Methyl red (0.0002) | | | | |
| 6 | ⁽⁵⁾Compound (I-a) (1), PMMA (1.5), | Ex. 2/50/2 | 0.1 | 1.2 | 60 |
| | chloroform (4), ⁽²⁾TCE (2), | | | | |
| | Irgacure 784 (0.02) | | | | |
| 7 | ⁽⁵⁾Compound (I-a) (0.8), | Ex. 2/60/1 | 0.2 | 0.5 | 70 |
| | 2-naphtyl-1-oxyethylacrylate (0.2), | | | | |
| | polysulfone (1.5), chloroform (4), | | | | |
| | ⁽²⁾TCE (2), Irgacure 784 (0.02) | | | | |
| 8 | ⁽⁵⁾Compound (I-a) (0.9), | Ex. 2/40/4 | 0.2 | 0.5 | 70 |
| | N-vinylcarbazole (0.1), | | | | |
| | polysulfone (1.5), chloroform (4), | | | | |
| | ⁽²⁾TCE (2), Irgacure 784 (0.02) | | | | |
| 9 | ⁽⁵⁾Compound (I-a) (0.9), | Ex. 1/70/24 | 1 | 0.5 | 70 |
| | N-vinylcarbazole (0.1), the | | | | |
| | sol-gel solution of Preparation | | | | |
| | Example 2 (1.5), Irgacure 784 | | | | |
| | (0.02), Methyl red (0.0002) | | | | |
| 10 | ⁽⁵⁾Compound (I-b) (2), | Ex. 1/80/48 | 1 | 0.3 | 65 |
| | N-vinylcarbazole (0.1), the | | | | |
| | sol-gel solution of Preparation | | | | |
| | Example 2 (1.5), Irgacure 784 | | | | |
| | (0.02) | | | | |
| 11 | ⁽⁵⁾Cpmoound (I-c) (0.9) | Ex. 1/70/24 | 0.5 | 0.7 | 80 |
| | N-vinylcarbazole (0.1), | | | | |
| | ⁽⁴⁾IA (0.1), the sol-gel | | | | |
| | solution of Preparation | | | | |
| | Example 3 (1.5), Irgacure 784 | | | | |
| | (0.02), Methylene blue (0.0002) | | | | |
| 12 | ⁽⁵⁾Compound (I-d) (0.9), | Ex. 1/60/72 | 0.5 | 0.6 | 75 |
| | N-vinylcarbazole (0.1), the | | | | |
| | sol-gel solution of Preparation | | | | |
| | Example 4 (1.5), Irgacure 784 | | | | |
| | (0.02), Methyl red (0.0002) | | | | |
| 13 | ⁽⁵⁾Compound (I-e) (1), | Ex. 1/70/32 | 0.5 | 0.6 | 80 |
| | ⁽³⁾NVA (0.1), the sol-gel | | | | |
| | solution of Preparation | | | | |
| | Example 1 (2),Irgacure 184 | | | | |
| | (0.01), Irgacure 784 (0.01), | | | | |
| | Methyl red (0.0001) | | | | |
| 14 | ⁽⁵⁾Compound (I-f) (0.9), | Ex. 1/100/120 | 0.2 | 0.5 | 70 |
| | the sol-gel solution of | | | | |
| | Preparation Example 5 (2), | | | | |
| | Irgacure 184 (0.01), Irgacure | | | | |
| | 784 (0.01) | | | | |
| 15 | ⁽⁵⁾Compound (I-a) (0.8), | Ex. 1/80/60 | 0.2 | 0.3 | 98 |
| | the sol-gel solution of | | | | |
| | Preparation Example 3 (2), | | | | |
| | Irgacure 184 (0.01), Irgacure | | | | |
| | 784 (0.02) | | | | |

Foot note:
⁽¹⁾PMMA: polymethylmethacrylate,
⁽²⁾TCE: trichloroethane,
⁽³⁾NVA: 2(N-carbazolyl-1-oxyethyl)acrylate,
⁽⁴⁾IA: isobonylacrylate, and
⁽⁵⁾Compounds (I-a) to (I-f): (prepared by the method disclosed in Korean
Patent Application No. 2002-43890 or Korean Patent No. 357685)

(I-a)

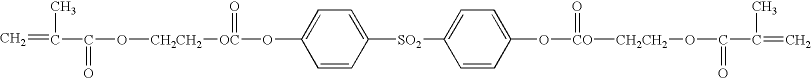

(I-b)

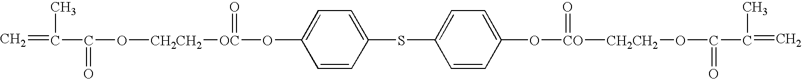

(I-c)

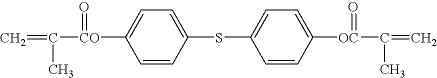

As shown in Table 2, the inventive photopolymerizable composition can provide a photopolymerizable film having an improved recording property which exhibits a low shrinkage value and a high refractive index change when photocured.

While the invention has been described with respect to the specific embodiments, it should be recognized that various modifications and changes may be made by those skilled in the art to the invention which also fall within the scope of the invention as defined by the appended claims.

1. A photopolymerizable composition which comprises 1) an acryl- or methacryl-based compound of formula (I), 2) a binder which is a sol-gel solution obtained from a siloxane precursor of formula (II) or a transparent polymeric resin, and 3) a photoinitiator: 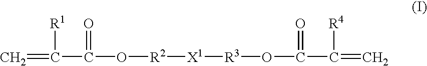
wherein:
R¹ and R⁴ are each independently hydrogen or CH₃;
R² and R³ are each independently R⁵ or 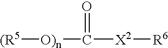
(R⁵ and R⁶ are each independently C₁₋₁₀ alkylene, arylene, —OCH₂CH₂—, —SCH₂CH₂— or 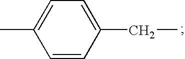
and n is an integer in the range of 1 to 10); and
X¹ is O, S, SO₂, 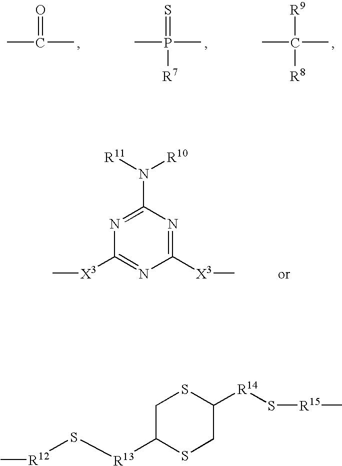
(X² and X³ are each independently O or S;
R⁷ is C₁₋₁₀ alkylthioether, phenyl, 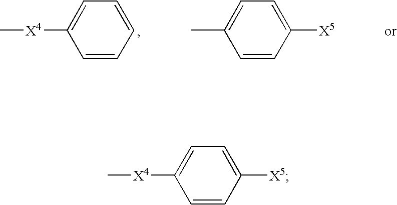
X⁴ is O, S, CH₂ or SCH₂; Xe is SCH₃, OCH₃ or phenyl; R⁸, R⁹, R¹⁰ and R¹¹ are each independently H, C₁₋₁₀ alkyl, C₃₋₁₀ cyclic alkyl, phenyl, benzyl or CF₃; and R¹², R¹³, R¹⁴ and R¹⁵ are each independently C₁₋₁₀ alkylene). 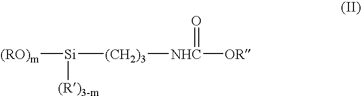
wherein:
R and R′ are each independently C₁₋₁₀ alkyl or phenyl;
R″ is —(R—O)ₚ—Y;
Y is R′, CF₃, SO₂CH₃ or 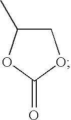
p is an integer in the range of 1 to 10; and
m is 0, 1, 2 or 3.

2. The photopolymerizable composition of claim 1 which comprises 1 to 80% by weight of the component 1), 19.99 to 98% by weight of the component 2) and 0.01 to 10% by weight of the component 3).

3. The photopolymerizable composition of claim 1, wherein the sol-gel solution is prepared by sol-gel reacting the siloxane precursor of formula (II) and tetraalkoxysilane in the presence of a basic catalyst.

4. The photopolymerizable composition of claim 1, wherein the transparent polymeric resin is selected form the group consisting of polyolefins, polystyrenes, polycarbonates, polyurethanes, polysulfones, polyacrylates and mixtures thereof

5. The photopolymerizable composition of claim 1 which comprises the transparent polymeric resin as a binder and further comprises at least one solvent which is selected from the group consisting of chloroform, dichloromethane, tetrahydrofuran, N-methylpyrrolidone, methylsulfoxide, N,N-dimethylacetamide, dioxane, alcohols, benzene, ethylene glycol dimethyl ether, acetonitrile and water.

6. The photopolymerizable composition of claim 1, wherein the photoinitiator is selected from the group consisting of Irgacure 184, Irgacure 784, a metallocene catalyst, Darocure, acridine, phenazine, quinoxaline and a mixture thereof.

7. A photopolymerizable film which is prepared by coating the composition of claim 1 on a substrate and drying the coating at room temperature to 130° C. for 30 min to 14 days.

8. An optical product obtained by irradiating a light to one part or all of the film of claim 7.
